(19) United States
(12) Patent Application Publication
(10) Pub. No.: US 2025/0379395 A1
(43) Pub. Date: Dec. 11, 2025

(54) Electrical Connector for Extreme Conditions

(71) Applicant: Petram Technologies, Inc., Jersey City, NJ (US)

(72) Inventors: Nicholas Magnotti, Boston, MA (US); Brian Wells, Notasulga, AL (US)

(73) Assignee: Petram Technologies, Inc., Jersey City, NJ (US)

(21) Appl. No.: 18/738,255

(22) Filed: Jun. 10, 2024

(51) Int. Cl. H01R 13/533; E21B 17/02; H01R 13/00; H01R 13/53

(52) U.S. Cl. CPC H01R 13/533; H01R 13/005; H01R 13/53; E21B 17/028

(57) ABSTRACT

A device may include a circular connector flange with a plurality of holes located within a circumference of the circular connector flange and a center through hole with a ledge. A device may include a circular dielectric spacer sized to fit in the center through hole on the ledge with a surface opposite the ledge with the circular connector flange surface. A device may include a concentric conductor circle within the circular dielectric spacer, the concentric conductor circle configured to connect to a wire on a side of the concentric conductor circle on the ledge and configured to mate with a similar conductor circle on the surface opposite the ledge.

### CROSS REFERENCE TO RELATED APPLICATIONS

This is a priority patent application.

This non-provisional application draws from U.S. Pat. No. 8,628,146, filed by Martin Baltazar-Lopez and Steve Best, issued on Jan. 14, 2010, entitled “Method of and apparatus for plasma blasting”, U.S. patent application Ser. No. 16/279,903, “Apparatus for Plasma Blasting” and U.S. patent application Ser. No. 16/409,607, “Novel Multi-Firing Swivel Head Probe for Electro-Hydraulic Fracturing in Down Hole Fracking Applications”. The entire patent and patent applications are entirely incorporated herein by reference.

### BACKGROUND

### Technical Field

The present invention relates to the field of electrical connectors. More specifically, the present invention relates to high voltage, high amperage electrical connections for environments with hydrostatic pressures in excess of 1000 PSI.

### Context

Plasma blasting is used to excavate rock, remove obstacles, fracture rock, and to break up ledge. The blast itself creates an adverse environment, with the equipment used for plasma blasting enduring the forces of the explosion. In addition, most locations where the basting is used are difficult. Whether underwater, at a construction site, or down a borehole, the environments can be very difficult. Combining an adverse blast condition with a very difficult environment requires equipment designed for extreme conditions.

Electrically powered plasma blasting uses a capacitor bank that is charged over a relatively long period of time at a low current and then discharged in a very short pulse at a very high current into a blasting probe comprised of two or more electrodes immersed in a fluid media. In some embodiments, the electrical discharges from the capacitor banks have a potential of more than 30 kV and peak currents upwards of 170 kA.

In one environment, plasma blasting is used by marine engineers to remove obstacles from a waterway, to place underwater pipes or cables, or to perform mining at the bottom of the ocean. To use the blasting equipment at the average depth of the ocean (4300 meters), the pressure is 6000 PSI. At these pressures, electrical interconnections are not available.

Another extreme environment for plasma blasting involves fracking in the expansion of water, oil, or gas wells. Fracking is the process of injecting liquid at high pressure into subterranean rocks, boreholes, etc., so as to force open existing fissures and extract water, oil, or gas. In this method, a capacitor bank is charged over a relatively long period of time at a low current and then discharged in a very short pulse at a very high current into a blasting probe comprised of two or more electrodes immersed in a fluid media. The fluid media is in direct contact with the borehole wall to be fractured.

Boreholes range from a few meters to tens of thousands of meters. This creates both temperature, pressure, and physical constraints, especially in the area of the bend where it transitions from a vertical to a horizontal section. These holes vary in size from almost 100 mm to 1200 mm in diameter and the horizontal section can also be thousands of meters. The boreholes may be casing reinforced with concrete. These boreholes can have pressures of 1000-10,000 PSI.

The present set of inventions describes electrical interconnections able to withstand hydrostatic pressures in excess of 1,000 PSI, and upwards of 10,000 PSI while passing 170,000 amps at 30,000 volts.

### SUMMARY OF THE INVENTION

In some aspects, the techniques described herein relate to an electrical connector including a circular connector flange with a plurality of holes located within a circumference of the circular connector flange and a center through a hole with a ledge; a circular dielectric spacer sized to fit in the center through hole on the ledge with a surface opposite the ledge with the circular connector flange surface; and a concentric conductor circle within the circular dielectric spacer, the concentric conductor circle configured to connect to a wire on a side of the concentric conductor circle on the ledge and configured to mate with a similar conductor circle on the surface opposite the ledge.

In some aspects, the techniques described herein relate to an electrical connector wherein the plurality of holes are through holes.

In some aspects, the techniques described herein relate to an electrical connector wherein the plurality of holes are threaded.

In some aspects, the techniques described herein relate to an electrical connector wherein the circular connector flange has one or more concentric grooves configured to hold an o-ring.

In some aspects, the techniques described herein relate to an electrical connector wherein the one or more concentric grooves hold o-rings.

In some aspects, the techniques described herein relate to an electrical connector wherein the one or more concentric grooves hold a conductive coupling gasket.

In some aspects, the techniques described herein relate to an electrical connector wherein the circular connector flange is steel.

In some aspects, the techniques described herein relate to an electrical connector further including a second concentric conductor circle within the concentric conductor circle with a circular dielectric insulator between the concentric conductor circle and the second concentric conductor circle, the second concentric conductor circle configured to connect to a second wire on the side of the concentric conductor circle on the ledge and configured to mate with a similar second conductor circle on the surface opposite the ledge.

In some aspects, the techniques described herein relate to an electrical connector wherein the circular dielectric spacer is ceramic.

In some aspects, the techniques described herein relate to an electrical connector wherein the circular dielectric spacer is a fiberglass epoxy laminate.

In some aspects, the techniques described herein relate to an electrical connector wherein the circular dielectric spacer includes a concentric mating ring configured to align a second electrical connector.

In some aspects, the techniques described herein relate to an electrical connector wherein the concentric conductor circle rises above the surface opposite the ledge of the circular connector flange.

In some aspects, the techniques described herein relate to an electrical connector wherein the circular connector flange is a negative electrical connection.

In some aspects, the techniques described herein relate to an electrical connector wherein the concentric conductor circle is a positive electrical connection.

In some aspects, the techniques described herein relate to an electrical connector wherein the circular dielectric spacer includes a second concentric conductor circle.

In some aspects, the techniques described herein relate to an electrical connector wherein the second concentric conductor circle is a negative electrical connection.

In some aspects, the techniques described herein relate to an electrical connector wherein the circular dielectric spacer further includes a cylindrical void in a center.

In some aspects, the techniques described herein relate to an electrical connector wherein the cylindrical void in the center contains a signal wire.

In some aspects, the techniques described herein relate to an electrical connector wherein the cylindrical void in the center contains a gas distribution line.

In some aspects, the techniques described herein relate to an electrical connector wherein the cylindrical void in the center contains a fiber optic cable.

### BRIEF DESCRIPTION OF FIGURES

FIG. 1 shows the electrical connector for extreme conditions in a plasma blasting configuration in accordance with some embodiments of the present inventions.

FIG. 2 shows a perspective view of the electrical connector for extreme conditions in accordance with some embodiments of the present inventions.

FIG. 3 shows a perspective view of the female side of the electrical connector for extreme conditions in accordance with some embodiments of the Present Application.

FIG. 4 shows a perspective view of the male side of the electrical connector for extreme conditions in accordance with some embodiments of the Present Application.

FIG. 5 shows a cross-sectional view of the electrical connector for extreme conditions in accordance with some embodiments of the present inventions.

FIG. 6 shows a cross-sectional view of the female electrical connector for extreme conditions in accordance with some embodiments of the present inventions.

FIG. 7 shows an exploded side view of the electrical connector for extreme conditions in accordance with some embodiments of the present inventions.

FIG. 8 shows an exploded perspective view of the electrical connector for extreme conditions in accordance with some embodiments of the present inventions.

### DETAILED DESCRIPTION OF THE INVENTION

All illustrations of the drawings are for the purpose of describing selected versions of the present invention and are not intended to limit the scope of the present invention.

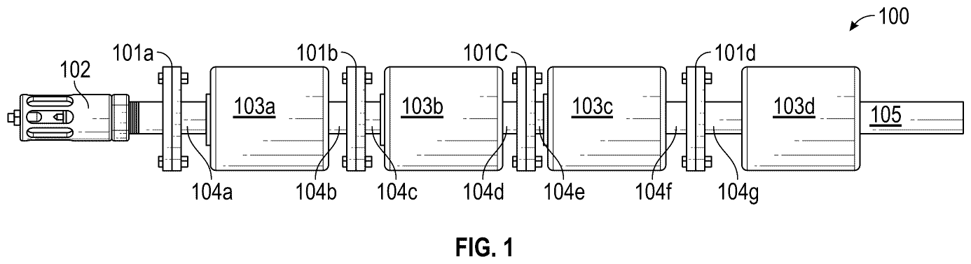

The drawing in FIG. 1 shows a system 100 including the electrical connector 101a-d for extreme conditions connecting a blasting probe 102 to a string of capacitors 103a-d with wires 104a-g. In this embodiment, the assembly of the capacitors and the blasting probe 102 are highly modular, with each component separated by wires 104a-g (optional) and electrical connectors 101a-d. Wires 104a-g could be of any length. On the right of FIG. 1, power comes into the first capacitor 103d at a normal level (perhaps 110/220 volts and 10-50 amps). First capacitor 103d is connected to wire 104g, which mechanically and electrically couples to connector 101d via wire 104g Wire 104f connects connector 101d to capacitor 103c. Capacitors 103b and 103c are connected by wires 104d and 104e through electrical connector 101c. Capacitors 103a and 103b are connected by wires 104b and 104c through electrical connector 101b. Probe 102 is directly connected to connector 101a Connector 101a is connected to capacitor 103a through wire 104a. In some embodiments, there is a switch or relay mechanism between wire 104a and the probe 102. Wires 104a-g are very high-voltage wires capable of handling over 30,000 volts and 170.000 amps. In this embodiment, the electrical current in wire 105 charges capacitors 103a-d. At the time of the blast, the capacitors 103a-d discharge in microseconds into the probe 102 causing a plasma blast in a gap between the high voltage electrodes in the blasting probe 102. A pressure wave created by the discharge plasma emanates from the blast region thereby fracturing a solid structure surrounding the blasting probe 102. See U.S. Pat. Nos. 8,628,146, 10,866,076, and 11,268,796 for more information on plasma blasting, each patent incorporated herein by reference.

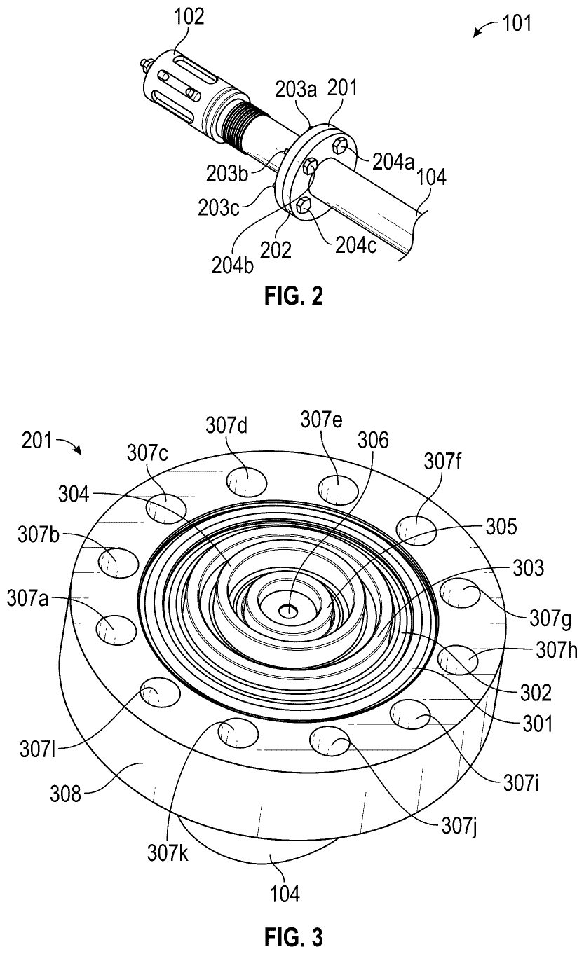

FIG. 2 shows a perspective view of the assembled electrical connector 101. The electrical connector 101 includes a female electrical connector 201 and a male electrical connector 202 bolted together with a plurality of nuts 203a-c and bolts 204a-c. In this example, female electrical connector 201 is connected to a blasting probe 102, and male electrical connector 202 is connected to wire 104.

FIG. 3 shows the female electrical connector 201 of the electrical connector 101. The electrical connector 101 will provide high-pressure sealing and be suited for high voltage, high current pulsed power applications. The electrical connector 101 will be able to provide suitable connections for electrical discharges with >30 kV potential between the conductors and peak currents upwards of 170 kA. Additionally, the termination sealing will be suitable for hydrostatic pressures in excess of 1,000 PSI, and upwards of 10,000 PSI.

The use of conductors 303,305,403,405 in a concentric ring orientation provides a substantially lower inductance design than offered by coaxial orientations typically employed. Additionally, the orientation of the mating conductors 303,305,403,405 in a concentric configuration provides significantly greater mechanical stability than a parallel conductor terminal. The Lorentz forces acting between the conductors 303,305,403,405 act radially and symmetrically, reducing the overall stress imposed on the housing and the likelihood of subsequent mechanical failure.

The surface area of the connection 303,305,403,405 is also maximized in this orientation, reducing contact resistances, leading to increased electrical efficiency, and reducing the degradation of the interfaces from thermal cycling and material erosion.

The use of concentric ring connections 303,305,403,405 also permits additional components or systems to be incorporated within the inner diameter 306,406 of the innermost conductor (e.g. signal lines, fiber cable, tensile members, gas distribution lines, etc.).

The electrical connector 101 consists of a bolted female flange 308 and bolted female flange 308, which each provide the seating and structure for the other components, and are depicted in the Figures. In some embodiments, both the bolted female flange 308 and the bolted female flange 308 are circular in shape.

The bolted female flange 308 is made of steel in one embodiment, but could also be made of other conductive materials such as stainless steel, copper, aluminum, carbon fiber, silver, gold, tungsten, zinc, nickel, lithium, iron, platinum, tin, lead, titanium, or similar, of dielectric materials such as G10 or G11 fiberglass epoxy laminate, porcelain, glass, plastic, etc; or insulating materials such as rubber, fiberglass, ceramics, quartz, or similar materials.

The bolted female flange 308 has a plurality of bolt holes 307a-1 around the circumference of the bolted female flange 308. In one embodiment, the bolted female flange 308 is 108 mm OD (outside diameter). In some embodiments, there are twelve bolt holes around the bolted female flange 308. In another embodiment, there are ten bolt holes around the bolted female flange 308. In some embodiments, the bolt holes 307a-1 are evenly spaced around the bolted female flange 308. In some embodiments, the bolt holes 307a-1 are 13 mm in diameter and 19 mm apart, 3 mm from the circumference of the bolted female flange 308. In one embodiment, the bolted female flange 308 is 25 mm thick.

The bolted female flange 308 may have an outer o-ring groove 301 on the mating surface. This outer o-ring groove 301 may be 1.5 mm wide and 1.5 mm deep and may hold an o-ring. The outside diameter of the outer o-ring groove 301 may be 76 mm in diameter. One or more o-rings may be placed in the outer o-ring groove 301.

The bolted female flange 308 may have an inner o-ring groove 302 on the mating surface. This inner o-ring groove 302 may be 1.5 mm wide and 1.5 mm and may hold an o-ring. The outside diameter of the inner o-ring groove 302 may be 60 mm in diameter. One or more o-rings may be placed in the inner o-ring groove 302. The inner o-ring may be of sufficient size to fit in the inner o-ring groove 302.

The bolted female flange 308 may have additional o-ring grooves and o-rings. The o-rings 301,302 may be made of AFLAS, Butadiene, Butyl, Chlorinated Polyethylene, Epichlorohydrin, Ethylene Acrylic, Ethylene Propylene, Fluorocarbon, Fluorosilicone, Isoprene, natural rubber, neoprene, HNBR, Nitrile, Buna N, Perfluorinater Fluoroelastomer, Polyacrylate, Polysulfide, Polyurethane, SBR, Buna S, Silicone or similar materials.

The bolted female flange 308 may have a conductor coupler ring 303. This conductor coupler ring 303 may sit in a conductor ring groove in the bolted female flange 308 that could be 1.5 mm wide and 1.5 mm deep. The outside diameter of the conductor coupler ring 303 may be 48 mm in diameter, 1.5 mm wide, and 2.0 mm in height. The conductor coupler ring 303 may be designed to rise slightly higher than the mating surface, so that when the female electrical connector 201 and male electrical connector 202 are bolted together, the conductor coupler ring 303 is forced down, compressing the conductor coupler ring 303 and causing a complete, solid contact with the male electrical connector 202 mating surface to permit a complete electrical connection. This solid electrical connection avoids pitting and sparking when current is applied. In some embodiments, the conductor coupler ring 303 provides the negative electrical branch of the circuit. The conductor coupler ring 303 could be copper, stainless steel, steel, aluminum, carbon fiber, silver, gold, tungsten, zinc, nickel, lithium, iron, platinum, tin, lead, titanium, or similar.

On the upper face of the bolted female flange 308, the slot provides a self-centering recess (aligner 501) between the mating flanges to make the electrical connection, via the conductor coupler ring 303. This component provides the electrical interface between the mating assemblies via an electrically conductive conductor coupler ring 303 and a high-pressure contact between the adjacent sides. This ring's 303 cross-section can either be solid, or of any shape to provide “spring” between the mating faces. If a “springy” gasket is used, the termination can withstand greater variability in axial deflections caused by external factors, such as mechanical loading, bolt tension loss, dimensional variability from thermal fluctuations, etc. The gasket 303 itself also provides sealing, particularly if a metal or composite seal is used. The seal can be similar to that of a kammprofile gasket, metal jacketed gasket, spiral wound gasket, or metal C- or E-Ring seal, as are used for high-pressure piping seals.

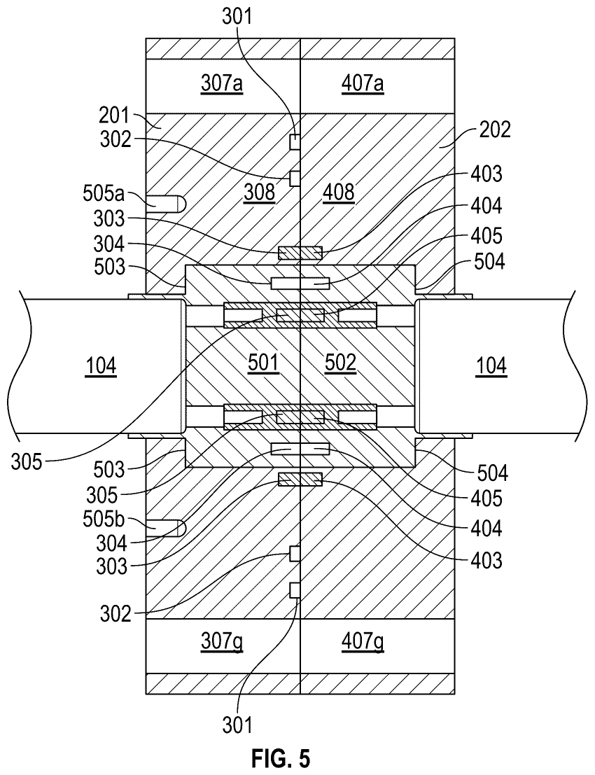

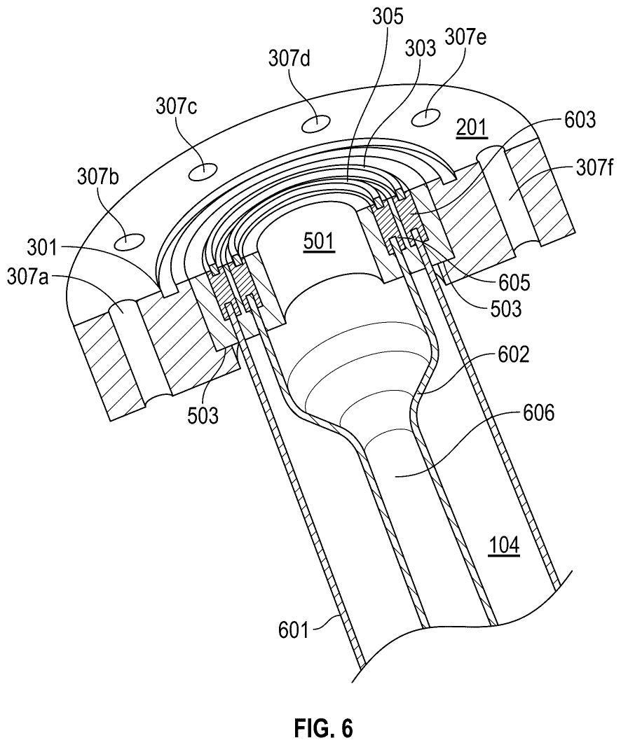

The bolted female flange 308 may have a round void 2 mm inside of the conductor coupler ring 303. This void may be 35 mm across and 25 mm deep. A ledge 503 may be located 18 mm down from the mating surface and extend 5 mm into the void. The ledge 503 could be integral to the bolted female flange 308, either cast as part of the bolted female flange 308 or milled into the bolted female flange 308. The ledge 503 is seen in FIGS. 5 and 6.

Against the bolted female flange 308 sits the aligner 501 that separates the conductor coupler ring 303 and the positive conductor ring 305 with the dielectric divider 304. The aligner 501 may be of a rigid and strong dielectric material, such as G10 or G11 fiberglass epoxy laminate. This aligner 501 component provides electrical insulation between the conductor coupler ring 303 and positive conductor ring 305, and provides a rigid surface to position the mating sides of the bolted female flange 308. The conductor coupler ring 303 and positive conductor ring 305 are rings of metal conductors (e.g. steel) that have slots in the upper and lower faces.

Inside the void in the bolted female flange 308 is a dielectric spacer and aligner 501. The dielectric spacer and aligner 501 may be 35 mm in diameter and 25 mm deep. At 18 mm deep from the mating surface, the aligner 501 may reduce its diameter by 5 mm to a 25 mm diameter for the remaining 7 mm. The aligner 501 is placed in the bolted female flange 308 resting on the ledge 503. The aligner 501 could be made of dielectric materials such as G10 or G11 fiberglass epoxy laminate, porcelain, glass, plastic, or similar materials, or of insulating materials such as rubber, fiberglass, ceramics, quartz, or similar materials.

The dielectric divider 304 of the aligner 501 provides additional protection against surface tracking dielectric discharge between the opposing polarity conductors 303,305. This component is of a dielectric nature and has the form of a ring and fits within the recess of the opposing divider mate 404.

The mating surface of the aligner 501 contains two concentric circles. The outermost circle is the dielectric divider 304. The dielectric divider 304 could have a 30 mm outside diameter and a 1.5 mm width. The dielectric divider 304 could be 3 mm from the outer edge of the aligner 501. The dielectric divider 304 and the conductor coupler ring 303 may be separated by a 6 mm air gap. The dielectric divider 304 could be 14 mm high, and sit in a 7 mm deep groove, so 7 mm rises above the mating surface. The dielectric divider 304 could be made of dielectric materials such as PTFE, G10 or G11 fiberglass epoxy laminate, porcelain, glass, plastic, or similar materials, or of insulating materials such as rubber, fiberglass, ceramics, quartz, or similar materials. In some embodiments, the dielectric divider 304 is integrated into the aligner 501 as a single piece.

4 mm inside of the dielectric divider 304 could be a positive conductor ring 305. The positive conductor ring 305 sits in a positive conductor ring groove in the aligner 501 that could be 1.5 mm wide and 1.5 mm deep. The outside diameter of the positive conductor ring 305 may be 20 mm in outside diameter, 1.5 mm wide, and 2.0 mm in height. The positive conductor ring 305 may be separated from the dielectric divider 304 by a 3 mm air gap. The positive conductor ring 305 may be designed to rise slightly higher than the mating surface, so that when the female electrical connector 201 and male electrical connector 202 are bolted together, the positive conductor ring 305 is forced down, compressing the positive conductor ring 305 and causing a complete, solid contact with the male positive connector ring 405 to permit a complete electrical connection. This solid electrical connection avoids pitting and sparking when current is applied. In some embodiments, the positive conductor ring 305 provides the positive electrical branch of the circuit. The positive conductor ring 305 could be copper, stainless steel, steel, aluminum, carbon fiber, silver, gold, tungsten, zinc, nickel, lithium, iron, platinum, tin, lead, titanium, or similar.

In some embodiments, there is a cylindrical opening 306 in the aligner 501 about 10 mm in diameter and passing through the width of the aligner 501. The cylindrical opening 306 could be separated from the positive conductor ring 305 by a 3.5 mm air gap. The cylindrical opening 306 could allow signal cables, fiber optics, tensile members, gas distribution lines, or similar.

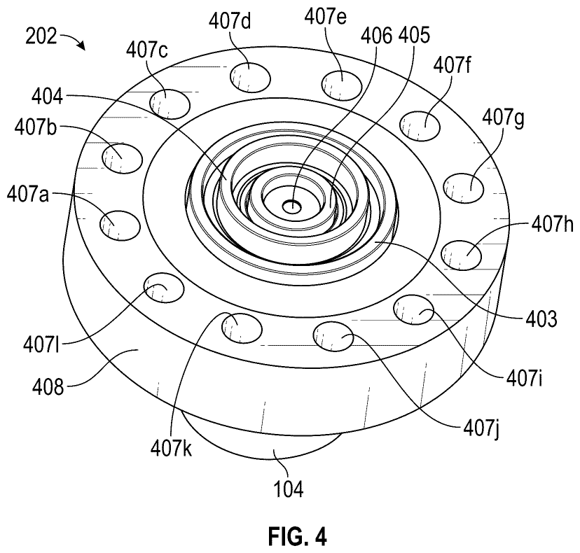

FIG. 4 shows the male electrical connector 202 of the electrical connector 101.

The bolted male flange 408 is made of steel in one embodiment, but could also be made of other conductive materials such as stainless steel, copper, aluminum, carbon fiber, silver, gold, tungsten, zinc, nickel, lithium, iron, platinum, tin, lead, titanium, or similar, of dielectric materials such as G10 or G11 fiberglass epoxy laminate, porcelain, glass, plastic, etc.; or insulating materials such as rubber, fiberglass, ceramics, quartz, or similar materials.

The male flange 408 has a plurality of bolt holes 407a-1 around the circumference of the male flange 408. In one embodiment, the male flange 408 is 108 mm OD (outside diameter). In some embodiments, there are twelve bolt holes around the male flange 408. In some embodiments, the bolt holes 407a-1 are evenly spaced around the male flange 408. In some embodiments, the bolt holes 407a-1 are 13 mm in diameter and 19 mm apart, 3 mm from the circumference of the male flange 408. In one embodiment, the male flange 408 is 25 mm thick.

The male flange 408 may be smooth in the areas opposite the outer o-ring groove 301 and inner o-ring groove 302 o-rings. In some embodiments, the male flange 408 may have o-ring grooves and o-rings.

The male flange 408 may have a conductor coupler ring 403. This conductor coupler ring 403 may sit in a conductor ring groove in the male flange 408 that could be 1.5 mm wide and 1.5 mm deep. The outside diameter of the conductor coupler ring 403 may be 48 mm in diameter, 1.5 mm wide, and 2.0 mm in height. The conductor coupler ring 403 may be designed to rise slightly higher than the mating surface, so that when the female electrical connector 201 and male electrical connector 202 are bolted together, the conductor coupler ring 403 is forced down, compressing the conductor coupler ring 403 and causing a complete, solid contact with the male electrical connector 202 mating surface to permit a complete electrical connection. In some embodiments, the conductor coupler ring 403 provides the negative electrical branch of the circuit. The conductor coupler ring 403 could be copper, stainless steel, steel, aluminum, carbon fiber, silver, gold, tungsten, zinc, nickel, lithium, iron, platinum, tin, lead, titanium, or similar. In some embodiments, conductor coupler ring 403 and conductor coupler ring 303 could be a single combined part rather than two parts.

The male flange 408 may have a round void 2 mm inside of the conductor coupler ring 403. This void may be 35 mm across and 25 mm deep. A ledge 503 may be located 18 mm down from the mating surface and extend 5 mm into the void. The ledge 504 could be integral to the male flange 408, either cast as part of the male flange 408 or milled into the male flange 408. The ledge 504 is seen in FIGS. 5 and 6.

Against the male flange 408 sits the female aligner 502 that separates the conductor coupler ring 403 and the positive conductor ring 405 with the dielectric divider 404. The male aligner 502 may be of a rigid and strong dielectric material, such as G10 or G11 fiberglass epoxy laminate. This male aligner 502 component provides electrical insulation between the conductor coupler ring 403 and positive conductor ring 405, and provides a rigid surface to position the mating sides of the male flange 408. The conductor coupler ring 403 and positive conductor ring 405 are rings of metal conductors (e.g. steel) that have slots in the upper and lower faces.

Inside the void in the male flange 408 is a dielectric spacer and male aligner 502. The male aligner 502 may be 35 mm in diameter and 25 mm deep. At 18 mm deep from the mating surface, the male aligner 502 may reduce its diameter by 5 mm to a 25 mm diameter for the remaining 7 mm. The male aligner 502 is placed in the male flange 408 resting on the ledge 504. The male aligner 502 could be made of dielectric materials such as G10 or G11 fiberglass epoxy laminate, porcelain, glass, plastic, or similar materials, or of insulating materials such as rubber, fiberglass, ceramics, quartz, or similar materials.

The male aligner 502 has an opposing divider mate 404 slot for receiving the dielectric divider 304 from the aligner 501. The dielectric divider 304 of the aligner 501 provides additional protection against surface tracking dielectric discharge between the opposing polarity conductors 403,405. This dielectric divider 304 is of a dielectric nature and has the form of a ring and fits within the recess of the divider mate 404. In some embodiments, opposing divider mate 404 and conductor coupler ring 403 could be a single combined part rather than two parts.

The mating surface of the male aligner 502 contains two concentric circles. The outermost circle is the opposing divider mate 404. The opposing divider mate 404 could have a 30 mm outside diameter and a 1.5 mm width. The opposing divider mate 404 could be 3 mm from the outer edge of the male aligner 502. The opposing divider mate 404 and the conductor coupler ring 403 may be separated by a 6 mm air gap. The opposing divider mate 404 could be a 7 mm deep groove, 1.5 mm wide.

4 mm inside of the opposing divider mate 404 could be a positive conductor ring 405. The positive conductor ring 405 sits in a positive conductor ring groove in the male aligner 502 that could be 1.5 mm wide and 1.5 mm deep. The outside diameter of the positive conductor ring 405 may be 20 mm in outside diameter, 1.5 mm wide, and 2.0 mm in height. The positive conductor ring 405 may be separated from the opposing divider mate 404 by a 3 mm air gap. The positive conductor ring 405 may be designed to rise slightly higher than the mating surface, so that when the female electrical connector 201 and male electrical connector 202 are bolted together, the positive conductor ring 405 is forced down, compressing the positive conductor ring 305 and causing a complete, solid contact with the male positive connector ring 405 to permit a complete electrical connection. This solid electrical connection avoids pitting and sparking when current is applied. In some embodiments, the positive conductor ring 405 provides the positive electrical branch of the circuit. The positive conductor ring 405 could be copper, stainless steel, steel, aluminum, carbon fiber, silver, gold, tungsten, zinc, nickel, lithium, iron, platinum, tin, lead, titanium, or similar.

In some embodiments, there is a cylindrical opening 406 in the male aligner 502 about 10 mm in diameter and passing through the width of the male aligner 502. The cylindrical opening 406 could be separated from the positive conductor ring 405 by a 3.5 mm air gap. The cylindrical opening 406 could allow signal cables, fiber optics, tensile members, gas distribution lines, or similar.

FIG. 5 shows a cross-section of the electrical connector 101 mated together. Female electrical connector 201 and male electrical connector 202 are pressed together, and held in place by bolts inserted in the bolt holes 307a-1, 407a-l. In some embodiments, the bolts 204a-c are secured with a plurality of nuts 203a-c. In some embodiments, the bolt holes 307a-l or 407a-l of the bolted female flange 308 or the male flange 408 are threaded, and the bolts 204a-b use the threads to secure the electrical connector 101 together.

Outer o-ring groove 301 and inner o-ring groove 302 are visible in the female electrical connector 201.

Bolted female flange 308 contains two bolt holes 505a,b for receiving a component, such as a capacitor or a probe, directly to the female electrical connector 201.

In FIG. 5, the conductor coupler rings 303, 403 can be seen compressed against each other. In some embodiments, the conductor coupler rings 303, 403 can be brazed, soldered, or welded to the bolted female flange 308. In some embodiments, the conductor coupler rings 303,304 could be an integral part of the bolted female flange 308 (or male flange 408), cast or milled into the bolted female flange 308 (or male flange 408) when formed.

The aligner 501 and male aligner 502 are seen in FIG. 5, forced together, and in place, by the ledges 503,504. The aligner 501 has the dielectric divider 304 that is inserted into the male aligner 502. Positive conductor rings 305, 405 can also be seen compressed together. The positive conductor rings 305, 405 can be brazed, soldered, or welded through to the wire 104.

The connection of the positive wire 602 of the wire 104 to the positive conductor ring 305 can be seen in FIG. 6. The wire 104 has a positive wire 602 and a negative wire 601. The wire 104 may also have a center corridor 606 for signal cables, fiber optics, tensile members, gas distribution lines, or similar. The center corridor 606 connects to the cylindrical opening 306 and cylindrical opening 406.

The braids (or individual strands) of the positive wire 602 could be brazed, soldered, or welded to positive internal connector 605. The braids (or individual strands) of the negative wire 601 could be brazed, soldered, or welded to positive internal connector 603. The positive internal connector 603 and center corridor 606 could be made of copper, stainless steel, steel, aluminum, carbon fiber, silver, gold, tungsten, zinc, nickel, lithium, iron, platinum, tin, lead, titanium, or similar. In some embodiments, the braids or individual strands of the wires 601,602 pass through holes in the aligner 501. In some embodiments, the braids or individual strands of wire are brazed, soldered, or welded directly to the conductor coupler ring 303 and positive conductor ring 305.

Note that FIG. 6 is a slightly different embodiment than FIG. 5. In FIG. 6 the conductor coupler ring 303 is located in the aligner 501 rather than the bolted female flange 308.

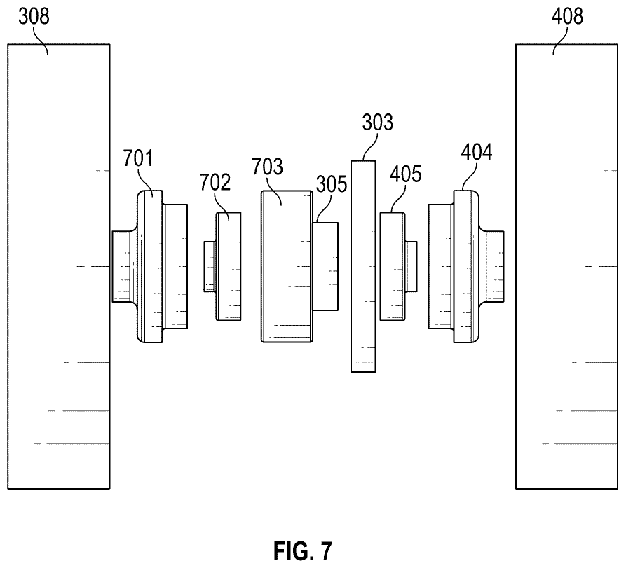

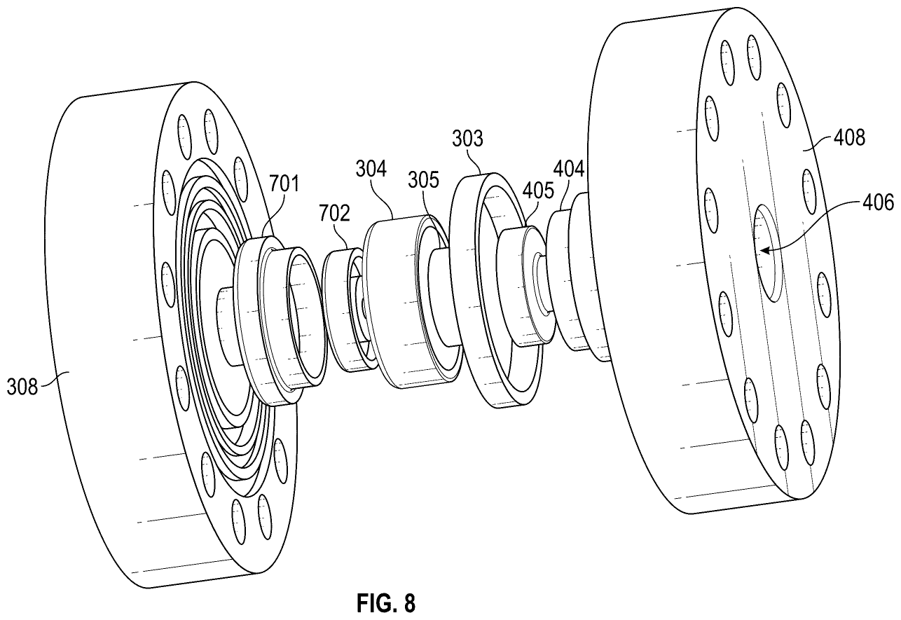

FIGS. 7 and 8 show still another embodiment from an exploded side and perspective views. In this embodiment, the bolted female flange 308 receives a dielectric divider 701. In some embodiments, dielectric divider 701 and opposing divider mate 404 are the same shape, and could be interchangeable. A dielectric ring 703 is inserted into the dielectric divider 701, which combined serves the function of dielectric divider 304 in this embodiment.

In some embodiments, the positive connector 702 is inserted into the dielectric divider 701. In some embodiments, the positive connector 702 is the same shape as the positive conductor ring 405, and could be interchangeable. The positive conductor ring 305 is inserted into the positive connector 702 in this embodiment. In other embodiments, the positive conductor ring 305 and the positive connector 702 are combined into a single part.

The conductor coupler ring 303 is inserted in the bolted female flange 308 to make the negative connection between the bolted female flange 308 and the male flange 408.

The opposing divider mate 404 is inserted into male flange 408, and then the positive conductor ring 405 is inserted into the opposing divider mate 404, in this embodiment.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims. All dimensions are given as examples, and may be changed without detracting from the inventions herein.

The foregoing devices and operations, including their implementation, will be familiar to, and understood by, those having ordinary skill in the art.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. An electrical connector comprising:
a circular connector flange with a plurality of holes located within a circumference of the circular connector flange and a center through hole with a ledge;
a circular dielectric spacer sized to fit in the center through hole on the ledge with a surface opposite the ledge with the circular connector flange surface; and
a concentric conductor circle within the circular dielectric spacer, the concentric conductor circle configured to connect to a wire on a side of the concentric conductor circle on the ledge and configured to mate with a similar conductor circle on the surface opposite the ledge.

2. The electrical connector of claim 1 wherein the plurality of holes are through holes.

3. The electrical connector of claim 1 wherein the plurality of holes are threaded.

4. The electrical connector of claim 1 wherein the circular connector flange has one or more concentric grooves configured to hold an o-ring.

5. The electrical connector of claim 4 wherein the one or more concentric grooves hold o-rings.

6. The electrical connector of claim 4 wherein the one or more concentric grooves hold a conductive coupling gasket.

7. The electrical connector of claim 1 wherein the circular connector flange is steel.

8. The electrical connector of claim 1 further comprising a second concentric conductor circle within the concentric conductor circle with a circular dielectric insulator between the concentric conductor circle and the second concentric conductor circle, the second concentric conductor circle configured to connect to a second wire on the side of the concentric conductor circle on the ledge and configured to mate with a similar second conductor circle on the surface opposite the ledge.

9. The electrical connector of claim 1 wherein the circular dielectric spacer is ceramic.

10. The electrical connector of claim 1 wherein the circular dielectric spacer is a fiberglass epoxy laminate.

11. The electrical connector of claim 1 wherein the circular dielectric spacer includes a concentric mating ring configured to align a second electrical connector.

12. The electrical connector of claim 1 wherein the concentric conductor circle rises above the surface opposite the ledge of the circular connector flange.

13. The electrical connector of claim 1 wherein the [symbol] flange is a negative electrical connection.

14. The electrical connector of claim 1 wherein the concentric conductor circle is a positive electrical connection.

15. The electrical connector of claim 1 wherein the circular dielectric spacer includes a second concentric conductor circle.

16. The electrical connector of claim 15 wherein the second concentric conductor circle is a negative electrical connection.

17. The electrical connector of claim 1 wherein the circular dielectric spacer further comprises a cylindrical void in a center.

18. The electrical connector of claim 17 wherein the cylindrical void in the center contains a signal wire.

19. The electrical connector of claim 17 wherein the cylindrical void in the center contains a gas distribution line.

20. The electrical connector of claim 17 wherein the cylindrical void in the center contains a fiber optic cable.
